(19) United States
(12) Patent Application Publication
(10) Pub. No.: US 2009/0219229 A1
(43) Pub. Date: Sep. 3, 2009

(54) METHOD FOR DRIVING PLASMA DISPLAY PANEL

(75) Inventors: Hajime HOMMA, Chuo-shi (JP); Yuichi Sakai, Chuo-shi (JP); Ayuhiko Saito, Chuo-shi (JP); Hideki Tanaka, Chuo-shi (JP); Masanori Ishihara, Chuo-shi (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Tokyo (JP)

(21) Appl. No.: 12/208,458

(22) Filed: Sep. 11, 2008

(30) Foreign Application Priority Data
Feb. 29, 2008 (JP) 2008-049611

(51) Int. Cl. G09G 3/28

(52) U.S. Cl. 345/63

(57) ABSTRACT

When the temperature of a plasma display panel falls outside a predetermined temperature range or when the time during which the plasma display panel is used exceeds a predetermined time, the largest potential difference between one row electrode and the other row electrode is reduced in a second half of a reset step.

### BACKGROUND OF THE INVENTION

1. Field of the Invention

The present invention relates to a method for driving a plasma display panel in accordance with an input video signal.

2. Description of the Related Art

AC (alternate discharge) plasma display panels (hereinafter, referred to as PDPs) are currently marketed commercially as a type of thin display apparatus. A PDP has two substrates; specifically, a front transparent substrate and a rear substrate, disposed facing each other with a predetermined gap therebetween. A plurality of row electrode pairs extending in the right-left direction of the screen is formed on an inner surface of the front transparent substrate (the surface facing the rear substrate) as a display plane. A dielectric layer is also formed over the inner surface of the front transparent substrate to cover the row electrode pairs. A plurality of column electrodes is formed on the rear substrate. The column electrodes extend in the up-down direction of the screen and cross the row electrode pairs. When viewed from the display plane, pixel cells that correspond to pixels are formed at intersections of the row electrode pairs and the column electrodes.

In such a PDP, a grayscale drive operation using a subfield method is carried out to provide intermediate display brightness values that correspond to an input video signal.

In a grayscale drive operation based on a subfield method, a display drive operation for a one-field video signal is carried out by using a plurality of subfields, each of which being assigned the number (or period) of luminescence to be made. In each of the subfields, an address step and a sustain step are sequentially carried out. In the address step, a selective discharge is selectively produced between the row electrode and the column electrode in each of the pixel cells to form (or erase) a predetermined amount of wall charge in accordance with the input video signal. In the sustain step, only the pixel cell in which a predetermined amount of wall charge has been formed repeatedly undergoes discharging to maintain the luminescence state accompanying the discharge. Further, at least in the first subfield, a reset step is carried out before the address step. In the reset step, a reset discharge is produced between the paired row electrodes in all of the pixel cells to initialize the amount of wall charge left in all of the pixel cells.

Since the reset discharge is relatively strong, and is unrelated to an image to be displayed, the luminescence accompanying the reset discharge disadvantageously lowers the contrast of the image.

To address the above problem, a PDP and a method for driving same have been proposed, the PDP and the method being characterized in that a protective layer provided over the front substrate contains a magnesium oxide crystal that produces cathode luminescence so as to shorten a discharge delay period (see Japanese Laid-Open Patent Publication No. 2006-106555, for example). Japanese Laid-Open Patent Publication No. 2006-106555 discloses a technology for changing a pulse width in accordance with the temperature of the PDP.

However, in a PDP using a cathode luminescence magnesium oxide crystal or another PDP having good discharge characteristics, an undesirable weak or feeble discharge may occur between electrodes Y and address electrodes in the address step. In such a case, the essential address discharge may not adequately occur between the electrodes Y and the address electrodes.

Further, in an abnormal temperature environment or in an aged apparatus, the discharge characteristics become unstable and the weak or feeble discharge described above readily occurs.

### SUMMARY OF THE INVENTION

An object of the invention is to provide a method for driving a plasma display panel that can reduce the effect of the weak or feeble discharge described above in a variety of conditions in which, for example, the apparatus temperature and the environment temperature change and changes occur over time, and therefore provide an excellent display quality and a high brightness grayscale representation capability (so-called dark contrast).

The invention provides a method for driving a plasma display panel in accordance with data for individual pixels based on a video signal, the plasma display panel including first and second substrates facing each other across a discharge space in which a discharge gas is sealed; discharge cells formed at intersections of a plurality of row electrode pairs each having first and second row electrodes that are formed on the first substrate, and a plurality of column electrodes that are formed on the second substrate; and a fluorescent layer formed on a surface in contact with the discharge space in each of the discharge cells, the fluorescent layer containing a fluorescent material; the method comprising: an address step of setting the discharge cell to one of a turn-on mode and a turn-off mode selectively in each of a plurality of subfields for individual unit display periods in the video signal; and a sustain step. In one of the plurality of subfields, a reset step of initializing the discharge cell to the other one of the turn-on mode and the turn-off mode is carried out before the address step. The reset step includes a first half of the reset step in which a first reset pulse is applied to the first row electrode, and a second half of the reset step that follows the first half of the reset step and in which a second reset pulse having a polarity that is opposite that of the first reset pulse is applied to the first row electrode. When a temperature of the plasma display panel falls outside a predetermined temperature range, the largest potential difference between the first and second row electrodes is reduced in the second half of the reset step.

In the method for driving a plasma display panel according to the invention, when an accumulated time over which the plasma display panel is used exceeds a predetermined time, or when an accumulated number of applications of a drive pulse that contributes to a grayscale display exceeds a predetermined value, the largest potential difference between the first and second row electrodes is reduced in the second half of the reset step.

According to the present invention, the largest potential difference between row electrodes (electrodes X and Y) is reduced in conditions under which a weak or feeble discharge readily occurs; for example, when the temperature of a PDP falls outside a predetermined temperature range (a higher or lower temperature) and when the PDP has been used longer than a predetermined time period.

Such a configuration allows the amount of wall charge on the Y and X electrodes that is left at the end of a reset step (during a write address step) to increase and a write address discharge to readily occur, whereby write failure can be effectively prevented.

### BRIEF DESCRIPTION OF THE DRAWINGS

FIG. 1 shows a schematic configuration of a plasma display apparatus in which a plasma display panel is driven in accordance with a driving method of the invention;

FIG. 2 is a front view diagrammatically showing the internal structure of a PDP as viewed from a display plane;

FIG. 3 is a cross-sectional view taken along the line V-V shown in FIG. 2;

FIG. 4 is a cross-sectional view taken along the line W-W shown in FIG. 2;

FIG. 5 diagrammatically shows an MgO crystal contained in a fluorescent layer 17;

FIG. 6 shows the transition of the intensity of column-side cathode discharge produced in a conventional PDP in which only a magnesium oxide layer contains a CL luminescence MgO crystal;

FIG. 7 shows the transition of the intensity of column-side cathode discharge produced in a PDP in which both a magnesium oxide layer and a fluorescent layer contain a CL luminescence MgO crystal;

FIG. 8 shows a sample luminescence pattern for each grayscale in the plasma display apparatus shown in FIG. 1;

FIG. 9 shows a sample luminescence drive sequence employed in the plasma display apparatus shown in FIG. 1;

FIG. 10 shows a variety of drive pulses applied to the PDP 50 in accordance with the luminescence drive sequence shown in FIG. 9;

FIG. 11 shows a schematic configuration of a plasma display apparatus that is a second embodiment of the invention; and

FIG. 12 shows a schematic configuration of a plasma display apparatus that is a third embodiment of the invention.

### DESCRIPTION OF THE PREFERRED EMBODIMENTS

Embodiments of the invention will be described below with reference to the drawings.

### First Embodiment

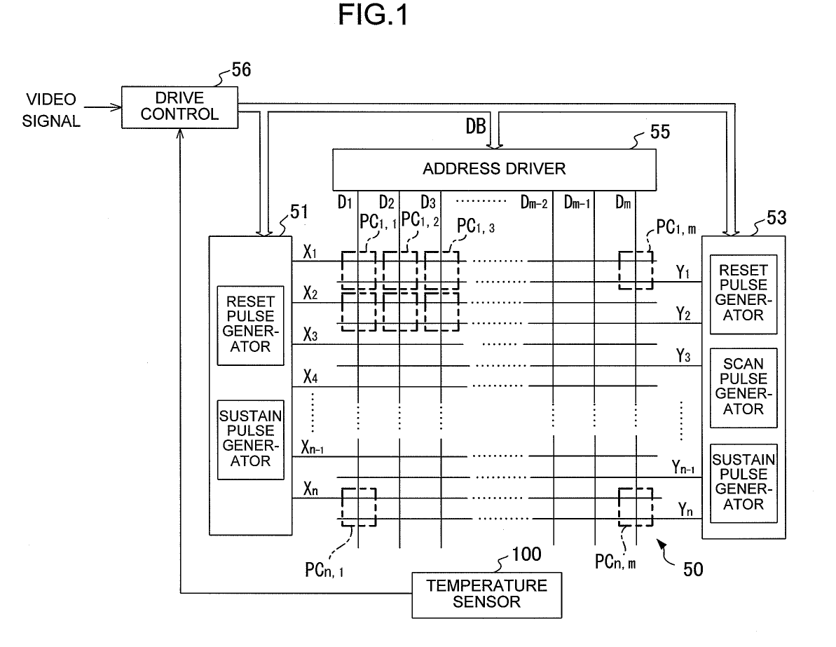

FIG. 1 shows a schematic configuration of a plasma display apparatus that is a first embodiment of the present invention.

As shown in FIG. 1, the plasma display apparatus includes a PDP 50 as a plasma display panel, an X-electrode driver 51, a Y-electrode driver 53, an address driver 55, a drive control circuit 56, and a temperature sensor 100.

The PDP 50 has the following electrodes formed therein: column electrodes D₁ to Dₘ arranged so as to extend in the longitudinal direction (vertical direction) of a two-dimensional display screen, and row electrodes X₁ to Xₙ and Y₁ to Yₙ arranged so as to extend in the transverse direction (horizontal direction). Row electrode pairs (Y₁, X₁), (Y₂, X₂), (Y₃, X₃), . . . , (Yₙ, Xₙ) form first to n-th display lines in the PDP 50, with each pair being a pair of adjacent electrodes. A discharge cell (display cell) PC that forms a pixel is formed at the intersection of each of the display lines and each of the column electrodes D₁ to Dₘ (the area surrounded by the dashed line in FIG. 1). Specifically, the PDP 50 has the following discharge cells arranged in a matrix: discharge cells PC_{1,1} to PC_{1,m} that belong to the first display line, discharge cells PC_{2,1} to PC_{2,m} that belong to the second display line, . . . , discharge cells PC_{n,1} to PC_{n,m} that belong to the n-th display line.

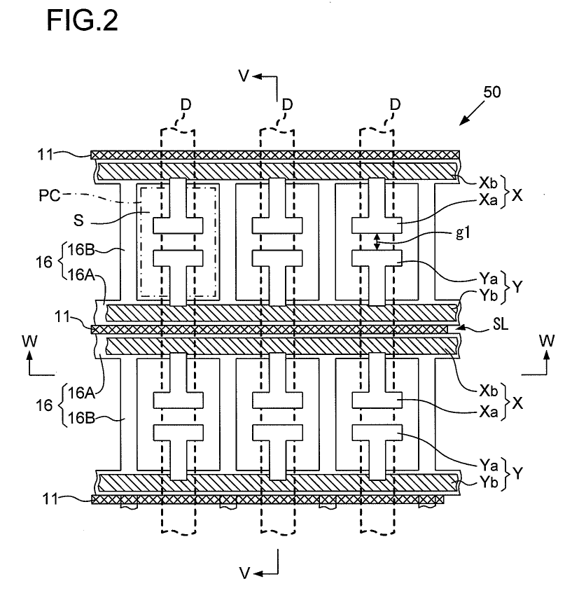

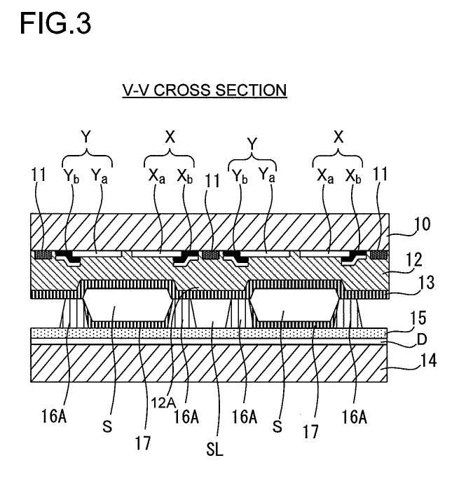

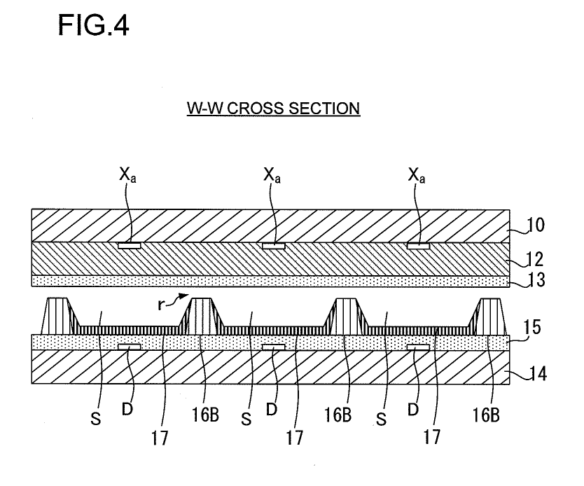

FIG. 2 is a front view diagrammatically showing the internal structure of the PDP 50 as viewed from a display plane. FIG. 2 shows an extracted portion including the intersections of three adjacent column electrodes D and two adjacent display lines. FIG. 3 is a cross-sectional view of the PDP 50 taken along the line V-V in FIG. 2. FIG. 4 is a cross-sectional view of the PDP 50 taken along the line W-W in FIG. 2.

As shown in FIG. 2, each of the row electrodes X includes a bus electrode Xb extending in the horizontal direction of the two-dimensional display screen and a T-shaped transparent electrode Xa provided in contact with the bus electrode Xb in the position that corresponds to each of the discharge cells PC. Each of the row electrodes Y includes a bus electrode Yb extending in the horizontal direction of the two-dimensional display screen and a T-shaped transparent electrode Ya provided in contact with the bus electrode Yb in the position that corresponds to each of the discharge cells PC. Each of the transparent electrodes Xa and Ya is formed from an ITO film or other transparent conductive films, and each of the bus electrodes Xb and Yb is formed from a film made of metal or other materials. The row electrodes X, each of which being formed from the transparent electrode Xa and the bus electrode Xb, and the row electrodes Y, each of which being formed from the transparent electrode Ya and the bus electrode Yb, are formed on the backside of the front transparent substrate 10, the front side of which being the display plane of the PDP 50, as shown in FIG. 3. The transparent electrodes Xa and Ya in each of the row electrode pairs (X, Y) extend toward their counterparts in the paired row electrodes, and wide top sides of the electrodes face each other with a discharge gap g1 having a predetermined width therebetween. A black or dark-colored light absorbing layer (light blocking layer) 11 extending in the horizontal direction of the two-dimensional display screen is formed on the backside of the front transparent substrate 10 between adjacent row electrode pairs (X, Y). A dielectric layer 12 is further formed over the backside of the front transparent substrate 10 to cover the row electrode pairs (X, Y). Raised dielectric layers 12A are formed on the backside of the dielectric layer 12 (the surface that is opposite the surface in contact with the row electrode pairs) in the portions that correspond to the areas where the light absorbing layer 11 and the bus electrodes Xb and Yb adjacent thereto are formed, as shown in FIG. 3.

A magnesium oxide layer 13 is formed on the surfaces of the dielectric layer 12 and the raised or protruding dielectric layers 12A. The magnesium oxide layer 13 contains a magnesium oxide crystal as a secondary electron emitting material that is excited by electron beam irradiation to emit CL (cathode luminescence) having a peak wavelength ranging from 200 to 300 nm, and especially 230 to 250 nm (hereinafter referred to as a CL luminescence MgO crystal). The CL luminescence MgO crystal is obtained by heating magnesium and causing the resulting magnesium vapor to undergo vapor-phase oxidation, and has, for example, a multiple crystal structure in which cubic crystals fit into one another or a cubic single crystal structure. The average particle diameter of the CL luminescence MgO crystal is at least 2000 angstroms (as a result of measurement using a BET method). To form a vapor-phase magnesium oxide single crystal having a large average particle diameter of at least 2000 angstroms, the heating temperature at which the magnesium vapor is produced needs to be elevated. For this reason, the length of flame in which magnesium reacts with oxygen becomes longer, and the difference in temperature between the flame and the surroundings becomes higher, whereby a vapor-phase magnesium oxide single crystal having a larger particle diameter is more likely to have an energy level that corresponds to the CL luminescence peak wavelength described above (a wavelength close to 235 nm or ranging from 230 to 250 nm, for example). As compared to typical vapor-phase oxidation, the vapor-phase magnesium oxide single crystal produced by increasing the amount of magnesium to be vaporized per unit time to increase the area where magnesium reacts with oxygen so as to allow the magnesium to react with more oxygen has an energy level that corresponds to the CL luminescence peak wavelength described above.

Spraying, electrostatic application, or another method is used to attach such a CL luminescence MgO crystal to the surface of the dielectric layer 12 to form the magnesium oxide layer 13. The magnesium oxide layer 13 may alternatively be formed by using deposition or sputtering to form a thin magnesium oxide layer on the surface of the dielectric layer 12 and attaching a CL luminescence MgO crystal onto the thin magnesium oxide layer.

Each of the column electrodes D is formed on a rear substrate 14 disposed parallel to the front transparent substrate 10 in the positions that face the transparent electrodes Xa and Ya of each of the row electrode pairs (X, Y) in such a way that the column electrode D extends in the direction perpendicular to the row electrode pairs (X, Y). A white column electrode protective layer 15 that covers the column electrodes D is further formed over the rear substrate 14. A separation wall 16 is formed on the column electrode protective layer 15. The separation wall 16 includes transverse walls 16A and longitudinal walls 16B arranged in the form of a ladder, the transverse walls 16A extending in the transverse direction of the two-dimensional display screen in the positions that correspond to the bus electrodes Xb and Yb of each of the row electrode pairs (X, Y), and the longitudinal walls 16B extending in the longitudinal direction of the two-dimensional display screen in intermediate positions between adjacent column electrodes D. Further, the separation wall 16 in a ladder form shown in FIG. 2 is formed for each of the display lines of the PDP 50. A gap SL is present between adjacent separation walls 16, as shown in FIG. 2. The ladder-shaped separation wall 16 partitions the discharge cells PC, each including an independent discharge space S and the transparent electrodes Xa and Ya. A discharge gas containing xenon gas is sealed in the discharge space S. The portion between the discharge space S in each of the discharge cells PC and the gap SL is closed by the magnesium oxide layer 13 that abuts the transverse walls 16A, as shown in FIG. 3. As shown in FIG. 4, since each of the longitudinal walls 16B does not abut the magnesium oxide layer 13, there is a gap r therebetween. Specifically, the discharge spaces S in adjacent discharge cells PC in the transverse direction of the two-dimensional display screen communicate with each other through the gap r.

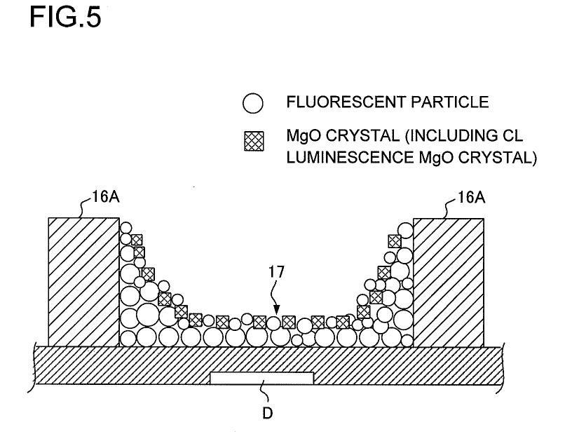

A fluorescent layer 17 is formed on side surfaces of the transverse walls 16A, side surfaces of the longitudinal walls 16B, and the surface of the column electrode protective layer 15 in each of the discharge cells PC in such a way that the fluorescent layer 17 covers the above surfaces. In practice, there are a fluorescent layer 17 made of a fluorescent material emitting red light, a fluorescent layer 17 made of a fluorescent material emitting green light, and a fluorescent layer 17 made of a fluorescent material emitting blue light. For example, the fluorescent layer 17 in each of the discharge cells PC that belong to (3K−2)-th column electrodes (D₁, D₄, D₇, D₁₀, . . . ) contains a fluorescent material emitting red light. Similarly, the fluorescent layer 17 in each of the discharge cells PC that belong to (3K−1)-th column electrodes (D₂, D₅, D₈, D₁₁, . . . ) contains a fluorescent material emitting green light, and the fluorescent layer 17 in each of the discharge cells PC that belong to (3K)-th column electrodes (D₃, D₆, D₉, D₁₂, . . . ) contains a fluorescent material emitting blue light. That is, discharge cells responsible for emitting light having one of the red, green, and blue colors are arranged on a single column electrode D. The fluorescent layer 17 contains an MgO crystal (including a CL luminescence MgO crystal) as a secondary electron emitting material, for example, in the form shown in FIG. 5. Specifically, as shown in FIG. 5, the MgO crystal in the fluorescent layer 17 is exposed at the surface that covers the discharge space S above the surface of the fluorescent layer 17, that is, at the surface in contact with the discharge space S so as to be in contact with the discharge gas.

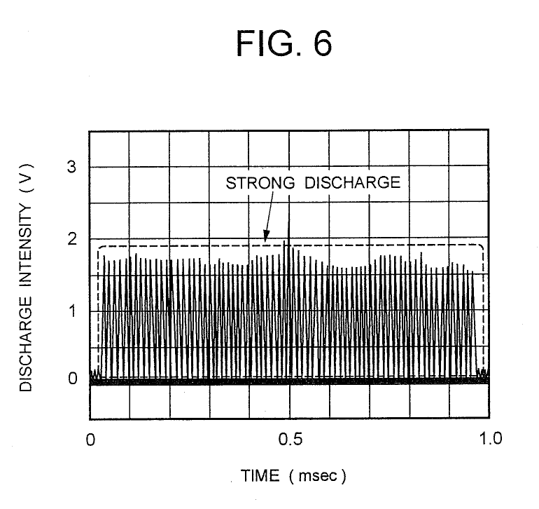

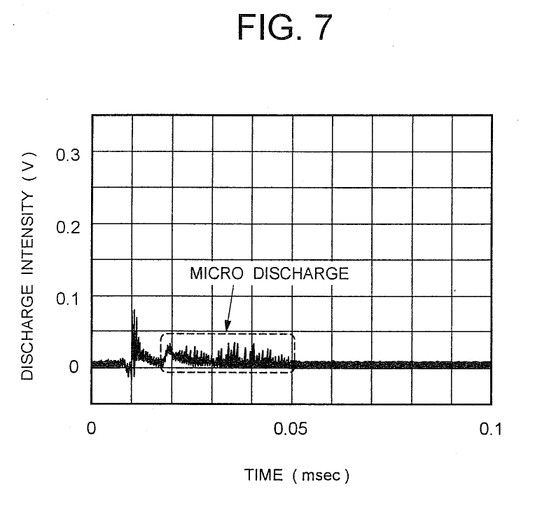

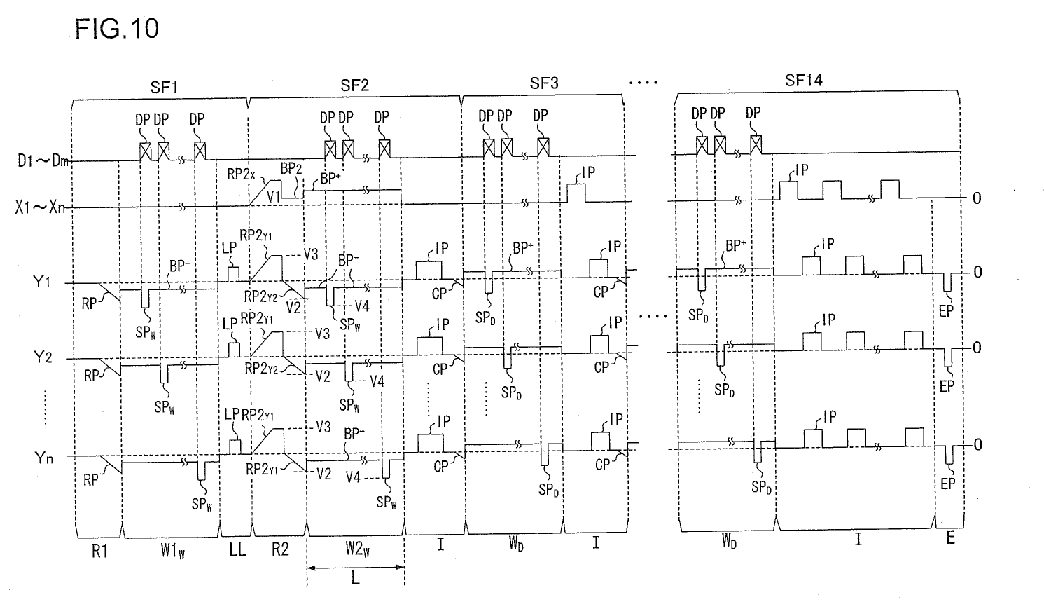

There follows a description of an advantageous effect provided by employing a configuration in which both the magnesium oxide layer 13 and the fluorescent layer 17 contain a CL luminescence MgO crystal with reference to FIGS. 6 and 7. In FIGS. 6 and 7, a pulse having the following waveform is applied to each of the electrodes. A slowly rising positive-polarity pulse is applied to the row electrodes Y, and the column electrodes D (address electrode) are set to a ground potential. A positive-polarity pulse having a magnitude at which discharge does not occur between the electrodes X and Y is applied to the row electrodes X. Specifically, the pulses are applied to the electrodes in a manner similar to a first half of a second reset step R2 in FIG. 10, which will be described later. In this case, discharge occurs between each of the row electrodes Y and each of the column electrodes D. Discharge that thus occurs as a result of a voltage applied in such a way that the row electrode Y becomes the anode and the column electrode D becomes the cathode is defined as “column-side cathode discharge.”

FIG. 6 shows the transition of the discharge intensity over time in the discharge produced in a discharge cell of a conventional PDP in which only the magnesium oxide layer 13 contains a CL luminescence MgO crystal but the fluorescent layer 17 does not. On the other hand, FIG. 7 shows the transition of the discharge intensity over time in the discharge produced in a discharge cell of the PDP 50 according to the invention in which both the magnesium oxide layer 13 and the fluorescent layer 17 contain a CL luminescence MgO crystal.

As seen from the drawings, in the conventional PDP, relatively strong discharge disadvantageously continues for at least 1 [ms] from the discharge start point, as shown in FIG. 6. According to the PDP 50 of the invention, however, a weak or feeble discharge is ended within approximately 0.04 [ms] from the discharge start point, as shown in FIG. 7. Therefore, employing a structure in which both the magnesium oxide layer 13 and the fluorescent layer 17 contain a CL luminescence MgO crystal allows the discharge delay period to be significantly shortened and the discharge to be weakened as compared to a conventional PDP.

The same result as in FIG. 6 is obtained in a discharge cell of a PDP in which the fluorescent layer 17 contains magnesium oxide containing no CL luminescence MgO crystal.

The X-electrode driver 51 includes a reset pulse generation circuit and a sustain pulse generation circuit. The reset pulse generation circuit of the X-electrode driver 51 generates a reset pulse (which will be described later) having a pulse waveform according to a reset pulse generation signal supplied from the drive control circuit 56, and applies the reset pulse to each of the row electrodes X₁ to Xₙ in the PDP 50. The sustain pulse generation circuit of the X-electrode driver 51 generates a sustain pulse (which will be described later) having a pulse waveform according to a sustain pulse generation signal supplied from the drive control circuit 56, and applies the sustain pulse to each of the row electrodes X₁ to Xₙ in the PDP 50.

The Y-electrode driver 53 includes a reset pulse generation circuit, a scan pulse generation circuit, and a sustain pulse generation circuit. The reset pulse generation circuit of the Y-electrode driver 53 generates a reset pulse (which will be described later) having a pulse waveform according to a reset pulse generation signal supplied from the drive control circuit 56 and applies the reset pulse to each of the row electrodes Y₁ to Yₙ in the PDP 50. The reset pulse generation circuit of the Y-electrode driver 53 also generates a wall charge adjustment pulse (which will be described later) having a pulse waveform according to a wall charge adjustment pulse generation signal supplied from the drive control circuit 56 and applies the wall charge adjustment pulse to each of the row electrodes Y₁ to Yₙ in the PDP 50. The scan pulse generation circuit of the Y-electrode driver 53 generates a scan pulse (which will be described later) having a pulse waveform according to a scan pulse generation signal supplied from the drive control circuit 56 and sequentially and selectively applies the scan pulse to each of the row electrodes Y₁ to Yₙ in the PDP 50. The sustain pulse generation circuit of the Y-electrode driver 53 generates a sustain pulse (which will be described later) having a pulse waveform represented by a sustain pulse generation signal supplied from the drive control circuit 56 and applies the sustain pulse to each of the row electrodes Y₁ to Yₙ in the PDP 50. The sustain pulse generation circuit of the Y-electrode driver 53 also generates a weak luminescence pulse (which will be described later) having a pulse waveform represented by a weak luminescence pulse generation signal supplied from the drive control circuit 56 and applies the weak luminescence pulse to each of the row electrodes Y₁ to Yₙ in the PDP 50.

The address driver 55 generates a pixel data pulse (which will be described later) having a peak potential according to a pixel drive data bit supplied from the drive control circuit 56 and applies the pixel data pulse to each of the column electrodes D₁ to Dₘ in the PDP 50. The address driver 55 also generates a supplementary pulse (which will be described later) in accordance with a supplementary pulse generation signal supplied from the drive control circuit 56 and applies the supplementary pulse to each of the column electrodes D₁ to Dₘ.

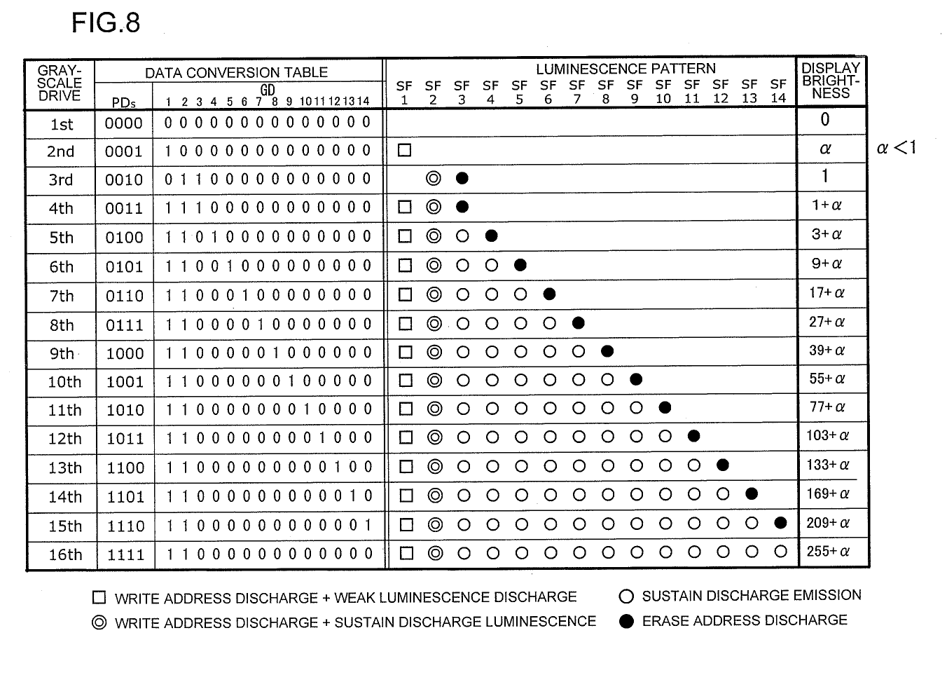

The drive control circuit 56 first converts an input video signal into 8-bit pixel data for each pixel, the 8-bit pixel data expressing the whole brightness range of the pixel in 256 grayscale levels, and performs multi-grayscaling including error diffusing and dithering on the pixel data. Specifically, first, in the error diffusing, the upper six bits of the pixel data are regarded as display data, and the remaining lower two bits are regarded as error data. Six-bit error diffused pixel data are then obtained by weighting and summing error data in pixel data that correspond to surrounding pixels and reflecting the result to the display data. According to such error diffusing, the brightness that corresponds to the lower two bits in the original pixel is virtually expressed by the surrounding pixels, whereby the 6-bit display data, which is fewer than 8 bit display data, can express brightness grayscales equivalent to that of the 8-bit pixel data described above. The drive control circuit 56 then performs dithering on the 6-bit error diffused pixel data obtained by the error diffusing. In the dithering, a plurality of pixels adjacent to one another are regarded as a single pixel unit, and dither coefficients having different values from one another are assigned to the error diffused pixel data that correspond to the pixels in the single pixel unit. The pixel data are summed up into dithered, summed pixel data. According to the dither-coefficient-based summing, in the view of the pixel unit described above, only the upper 4 bits of the dithered, summed pixel data are necessary to express the brightness that corresponds to 8 bits. The drive control circuit 56 then converts the upper 4 bits of the dithered, summed pixel data into 4-bit multi-grayscaled pixel data PD_{S} in which the whole brightness range is expressed in 16 steps, first to sixteenth grayscales, as shown in FIG. 8. The drive control circuit 56 then converts the multi-grayscale pixel data PD_{S} into 14-bit pixel drive data GD in accordance with a data conversion table shown in FIG. 8. The drive control circuit 56 relates the first to fourteenth bits in the pixel drive data GD to subfields SF1 to S 14 (which will be described later), respectively, and supplies the bit at the digit that corresponds to a subfield SF as a pixel drive data bit DB to the address driver 55. Such bits for one display line (m bits) are supplied at a time.

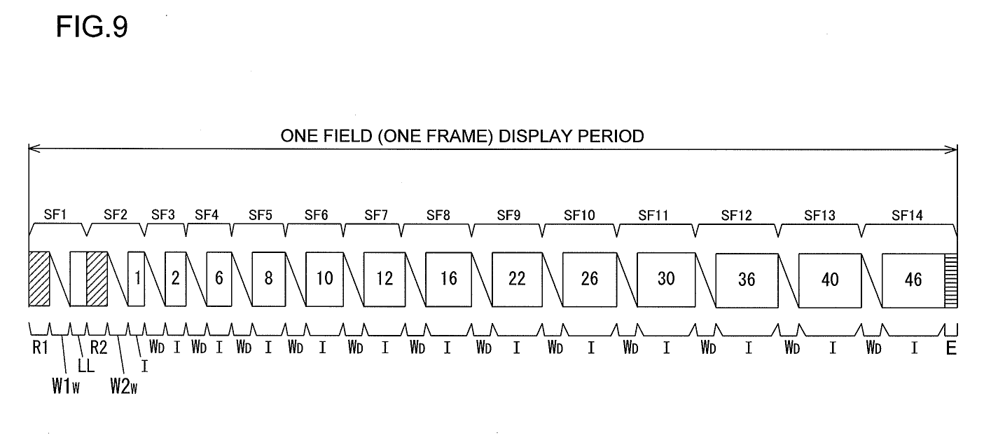

The drive control circuit 56 supplies a variety of drive control signals that should drive the PDP 50 in accordance with a luminescence drive sequence shown in FIG. 9 to the panel drivers (i.e., the X-electrode driver 51, the Y-electrode driver 53, and the address driver 55). Specifically, the drive control circuit 56 supplies drive control signals that should sequentially trigger drive operations according to a first reset step R1, a first selective write address step W1_{W}, and a weak luminescence step LL in the first subfield SF1 to the panel drivers for each field or frame display period (hereinafter referred to as a unit display period). In the subfield SF2 that follows SF1, drive control signals that should sequentially trigger drive operations according to a second reset step R2, a second selective write address step W2_{W}, and a sustain step I are supplied to the panel drivers. In each of the subfields SF3 to SF14, drive control signals that should sequentially trigger drive operations according to a selective erase address step W_{D} and the sustain step I are supplied to the panel drivers. Only in the subfield SF14, which is the last subfield in the unit display period, the drive control circuit 56, after executing the sustain step I, supplies a drive control signal that should trigger a drive operation according to an erase step E to the panel drivers.

The panel drivers (the X-electrode driver 51, the Y-electrode driver 53, and the address driver 55) supply drive pulses shown in FIG. 10 to the column electrodes D and the row electrodes X and Y in the PDP 50 in accordance with the variety of drive control signals supplied from the drive control circuit 56. FIG. 10 only shows operations in the first subfield SF1, the following subfield SF2, and the last subfield SF14 extracted from the subfields SF1 to SF14 shown in FIG. 9.

First, in the first reset step R1 in the subfield SF1, the address driver 55 sets the column electrodes D₁ to Dₘ to the ground potential (zero volts). The Y-electrode driver 53 generates a negative-polarity reset pulse RP having a waveform (ramp waveform) in which the potential at the front edge slowly changes with time and applies it to all of the row electrodes Y₁ to Yₙ. The negative peak potential of the reset pulse RP is set to a potential higher than the peak potential of a negative-polarity write scan pulse SP_{W}, which will be described later, that is, a potential closer to zero volts. Specifically, when the peak potential of the reset pulse RP is lower than the peak potential of the write scan pulse SP_{W}, strong discharge occurs between the row electrodes Y and the column electrodes D, and hence the amount of wall charge formed in the vicinity of each of the column electrode D is significantly reduced, resulting in unstable address discharge in the first selective write address step W1_{W}. During the above period, the X-electrode driver 51 sets all of the row electrodes X₁ to Xₙ to the ground potential (zero volts). The application of the reset pulse RP causes a reset discharge between the row electrodes X and Y in each of the discharge cells PC. The reset discharge erases the wall charge left in the vicinity of each of the row electrodes X and Y in each of the discharge cells PC, and all of the discharge cells PC are initialized to a turn-off mode. The application of the reset pulse RP further causes a weak or feeble discharge between the row electrode Y and the column electrode D in each of the discharge cells PC. The weak discharge erases part of the positive-polarity wall charge formed in the vicinity of the column electrode D so as to adjust the wall charge to the amount that can adequately cause the selective write address discharge in the first selective write address step W1_{W}, which will be described later. The pulse voltage of the reset pulse RP is set to a value lower than the pulse voltage of a sustain pulse IP. The voltage applied by the reset pulse RP between the row electrodes X and Y in each of the discharge cells is lower than the voltage applied by the application of the sustain pulse IP between the row electrodes X and Y. The reset discharge caused by the application of the reset pulse RP is therefore weaker than the sustain discharge caused by the application of the sustain pulse IP.

In the first selective write address step W1_{W} in the subfield SF1, the Y-electrode driver 53 sequentially and selectively applies the write scan pulse SP_{W} having a negative-polarity peak potential to the row electrodes Y₁ to Yₙ, while at the same time applying a base pulse BP⁻ having a predetermined negative-polarity base potential to the row electrodes Y₁ to Yₙ, as shown in FIG. 10. During the above period, the address driver 55 first converts the pixel drive data bit that corresponds to the subfield SF1 into a pixel data pulse DP having a pulse voltage according to the logic level of the pixel drive data bit. For example, when a pixel drive data bit having a logic level “1” at which the discharge cell PC should be set to a turn-on mode is supplied, the address driver 55 converts the pixel drive data bit into a pixel data pulse DP having a positive-polarity peak potential. On the other hand, when the pixel drive data bit has a logic level “0” at which the discharge cell PC should be set to the turn-off mode, the pixel drive data bit is converted into a pixel data pulse DP having a low voltage (zero volts). The address driver 55 then applies the pixel data pulses DP for each display line (m pixel data pulses) to the column electrodes D₁ to Dₘ in synchronization with the application timing of the write scan pulse SP_{W}. In this process, selective write discharge occurs between the column electrode D and the row electrode Y in the discharge cell PC to which the write scan pulse SP_{W} is applied and at the same time the high-voltage pixel data pulse DP that should set the discharge cell PC to the turn-on mode is applied. During the above period, the voltage according to the write scan pulse SP_{W} is also applied between the row electrodes X and Y. In this stage, however, since all of the discharge cells PC are in the turn-off mode, that is, in the state in which the wall charge is erased, the application of the write scan pulse SP_{W} alone will not cause discharge between the row electrodes X and Y. Therefore, in the first selective write address step W1_{W} in the subfield SF1, the application of the write scan pulse SP_{W} and the high-voltage pixel data pulse DP causes the selective write address discharge only between the column electrode D and the row electrode Y in each of the corresponding discharge cells PC. In this way, although no wall charge is present in the vicinity of the row electrode X in such a discharge cell PC, the discharge cell PC is set to the turn-on mode in which positive-polarity wall charge is formed in the vicinity of the row electrode Y and negative-polarity wall charge is formed in the vicinity of the column electrode D. On the other hand, no selective write address discharge described above occurs between the column electrode D and the row electrode Y in the discharge cell PC to which the write scan pulse SP_{W} is applied and at the same time the pixel data pulse DP having a low voltage (zero volts) at which the discharge cell PC should be set to the turn-off mode is applied. Therefore, such a discharge cell PC maintains the turn-off mode state in which the discharge cell PC is initialized in the first reset step R1, that is, the state in which no discharge occurs between the row electrode Y and the column electrode D or between the row electrodes X and Y.

In the weak luminescence step LL in the subfield SF1, the Y-electrode driver 53 applies a weak luminescence pulse LP having a predetermined positive-polarity peak potential shown in FIG. 10 to the row electrodes Y₁ to Yₙ at the same time. The application of the weak luminescence pulse LP causes discharge (hereinafter referred to as weak luminescence discharge) between the column electrode D and the row electrode Y in the discharge cell PC set to the turn-on mode. That is, in the weak luminescence step LL, applying a potential that causes discharge between the row electrode Y and the column electrode D but not between the row electrodes X and Y in the discharge cell PC to the row electrodes Y causes weak luminescence discharge only between the column electrode D and the row electrode Y in the discharge cell PC set to the turn-on mode. The peak potential of the weak luminescence pulse LP is lower than the peak potential of the sustain pulse IP to be applied in the sustain step I in the subfield SF2, which will be described later, and in the following subfields. For example, the peak potential of the weak luminescence pulse LP has the same magnitude as that of a base potential applied to the row electrodes Y in the selective erase address step W_{D}, which will be described later. Further, as shown in FIG. 10, the rate of change in potential with time in the rising period of the weak luminescence pulse LP is higher than that in the falling period of the reset pulse RP. That is, the potential transition at the front edge of the weak luminescence pulse LP is made steeper than the potential transition at the front edge of the reset pulse so as to cause discharge stronger than the reset discharge that occurs in the first reset step R1 and the second reset step R2. Since such discharge is the column-side cathode discharge described above and caused by the weak luminescence pulse LP whose pulse voltage is smaller than that of the sustain pulse IP, the brightness of the luminescence accompanying such discharge is lower than that of the sustain discharge (which will be described later) that occurs between row electrodes X and Y. Specifically, the weak luminescence discharge that occurs in the weak luminescence step LL is discharge accompanied by luminescence having a brightness level higher than that of the reset discharge but lower than that of the sustain discharge, that is, discharge accompanied by weak luminescence to the extent usable for display. In the first selective write address step W1_{W} carried out immediately before the weak luminescence step LL, the selective write address discharge occurs between the column electrode D and the row electrode Y in a discharge cell PC. Therefore, in the subfield SF1, the luminescence accompanying the selective write address discharge and the luminescence accompanying the weak luminescence discharge express the brightness that corresponds to the grayscale that is one step higher than the brightness level 0. After the weak luminescence discharge has occurred, negative-polarity wall charge is formed in the vicinity of the row electrode Y, and positive-polarity wall charge is formed in the vicinity of the column electrode D.

In the first half of the second reset step R2 in the subfield SF2, the Y-electrode driver 53 applies a positive-polarity reset pulse (first reset pulse) RP2_{Y1} having a waveform in which the potential at the front edge changes with time more slowly than that of the sustain pulse, which will be described later, to all of the row electrodes Y₁ to Yₙ. The reset pulse (first reset pulse) RP2_{Y1} has a pulse height (fixed voltage value) V3.

During the above period, the address driver 55 sets the column electrodes D₁ to Dₘ to the ground potential (zero volts), and the X-electrode driver 51 applies a positive-polarity reset pulse RP2_{X} to all of the row electrodes X₁ to Xₙ, the reset pulse RP2_{X} having a peak potential that can prevent surface discharge between the row electrodes X and Y caused by the application of the reset pulse RP2_{Y1}. If no surface discharge occurs between the row electrodes X and Y, the X-electrode driver 51 may alternatively set all of the row electrodes X₁ to Xₙ to the ground potential (zero volts) instead of applying the reset pulse RP2_{X} thereto.

The application of the reset pulse RP2_{Y1} causes a first reset discharge between the row electrode Y and the column electrode D in the pixel cell PC in which no column-side cathode discharge occurs in the weak luminescence step LL, the first reset discharge being weaker than the column-side cathode discharge in the weak luminescence step LL.

Specifically, in the first half of the second reset step R2, column-side cathode discharge in which current flows from the row electrode Y to the column electrode D as the first reset discharge is caused by applying a voltage between the row electrode Y and the column electrode D in such a way that the row electrode Y is the anode and the column electrode D is the cathode. On the other hand, the application of the reset pulse RP2_{Y1} causes no discharge in the pixel cell PC in which the weak luminescence discharge has already occurred in the weak luminescence step LL. Therefore, immediately after the first half of the second reset step R2 has been completed, negative-polarity wall charge is formed in the vicinity of the row electrode Y and positive-polarity wall charge is formed in the vicinity of the column electrode D in each of the pixel cells PC.

In the second half of the second reset step R2 in the subfield SF2, the Y-electrode driver 53 applies a reset pulse (second reset pulse) RP2_{Y2} to the row electrodes Y₁ to Yₙ, the reset pulse RP2_{Y2} having a waveform (ramp waveform) in which the potential slowly decreases with time to a negative-polarity peak potential (final potential V2). Specifically, the second reset pulse has a polarity opposite to that of the first reset pulse in the first half of the second reset step R2 described above.

Further, in the second half of the second reset step R2, the X-electrode driver 51 applies a base pulse BP₂ having a predetermined fixed positive-polarity potential (V1) to the row electrodes X₁ to Xₙ. The application of the negative-polarity reset pulse RP2_{Y2} and the positive-polarity base pulse BP₂ causes a second reset discharge between the row electrodes X and Y in each of the pixel cells PC. The peak potential of each of the reset pulse RP2_{Y2} and the base pulse BP₂ is the smallest potential that can reliably cause the second reset discharge between the row electrodes X and Y in consideration of the wall charge formed by the first reset discharge in the vicinity of each of the row electrodes X and Y. The negative peak potential (V2) of the reset pulse RP2_{Y2} is set to a potential higher than the peak potential of the negative-polarity write scan pulse SP_{W}, that is, a potential closer to zero volts (a negative-polarity potential having a small absolute value). This is specifically because when the peak potential of the reset pulse RP2_{Y2} (V2) is lower than the peak potential of the write scan pulse SP_{W}, strong discharge occurs between the row electrode Y and the column electrode D, and hence the amount of wall charge formed in the vicinity of the column electrode D is significantly reduced, resulting in unstable address discharge in the second selective write address step W2_{W}. The second reset discharge caused in the second half of the second reset step R2 erases the wall charge formed in the vicinity of each of the row electrodes X and Y in each of the pixel cells PC, and all of the pixel cells PC are initialized to the turn-off mode. The application of the reset pulse RP2_{Y2} also causes a weak or feeble discharge between the row electrode Y and the column electrode D in each of the pixel cells PC, and such discharge erases part of the positive-polarity wall charge formed in the vicinity of the column electrode D so as to adjust the wall charge to the amount that can adequately cause the selective write address discharge in the second selective write address step W2_{W}.

In the second selective write address step W2_{W} in the subfield SF2, the Y-electrode driver 53 sequentially and selectively applies the write scan pulse SP_{W} having a negative-polarity peak potential to the row electrodes Y₁ to Yₙ, while at the same time applying the base pulse BP⁻ having a predetermined negative-polarity base potential to the row electrodes Y₁ to Yₙ, as shown in FIG. 10. The X-electrode driver 51 applies a base pulse BP⁺ having a predetermined positive-polarity base potential to the row electrodes X₁ to Xₙ in the second selective write address step W2_{W}. The potential of each of the base pulse BP⁻ and the base pulse BP⁺ is set in such a way that the voltage between the row electrodes X and Y in the period during which no write scan pulse SP_{W} is applied is lower than the voltage at which a discharge cell PC starts discharging. Further, in the second selective write address step W2_{W}, the address driver 55 first converts the pixel drive data bit that corresponds to the subfield SF2 into a pixel data pulse DP having a pulse voltage according to the logic level of the pixel drive data bit. For example, when a pixel drive data bit having the logic level 1 at which the discharge cell PC should be set to the turn-on mode is supplied, the address driver 55 converts the pixel drive data bit into a pixel data pulse DP having a positive-polarity peak potential. On the other hand, when the pixel drive data bit has the logic level 0 at which the discharge cell PC should be set to the turn-off mode, the pixel drive data bit is converted into a pixel data pulse DP having a low voltage (zero volts). The address driver 55 then applies the pixel data pulses DP for each display line (m pixel data pulses) to the column electrodes D₁ to Dₘ in synchronization with the application timing of the write scan pulse SP_{W}. In this process, selective write address discharge occurs between the column electrode D and the row electrode Y in the discharge cell PC to which the write scan pulse SP_{W} is applied and at the same time the high-voltage pixel data pulse DP that should set the discharge cell PC to the turn-on mode is applied. Immediately after the selective write address discharge has occurred, a weak discharge also occurs between the row electrodes X and Y in the discharge cell PC. That is, the write scan pulse SP_{W} is applied, and a voltage that corresponds to the base pulse BP⁻ and the base pulse BP⁺ is then applied between the row electrodes X and Y. Such a voltage alone, however, will not cause discharge in the discharge cell PC because the voltage is set to be lower than the voltage at which the discharge cells PC starts discharge. However, once the selective write address discharge occurs, the selective write address discharge induces discharge between the row electrodes X and Y when only the voltage based on the base pulse BP⁻ and the base pulse BP⁺ is applied. Such discharge will not occur in the first selective write address step W1_{W} in which no base pulse BP⁺ is applied to the row electrode X. Such discharge and the selective write address discharge described above set the discharge cell PC to the state in which positive-polarity wall charge is formed in the vicinity of the row electrode Y and negative-polarity wall charge is formed in the vicinity of each of the row electrode X and column electrode D in the discharge cell PC, specifically, the discharge cell is set to the turn-on mode. On the other hand, no selective write address discharge described above occurs between the column electrode D and the row electrode Y in the discharge cell PC to which the write scan pulse SP_{W} is applied and at the same time the pixel data pulse DP having a low voltage (zero volts) at which the discharge cell PC should be set to the turn-off mode is applied, whereby no discharge will occur between the row electrodes X and Y. Therefore, the discharge cell PC maintains the state immediately before this step, specifically, the turn-off mode state in which the discharge cell PC is initialized in the second reset step R2.

In the sustain step I in the subfield SF2, the Y-electrode driver 53 generates only one sustain pulse IP having a positive-polarity peak potential and applies it to the row electrodes Y₁ to Yₙ at the same time. During the above period, the X-electrode driver 51 sets the row electrode X₁ to Xₙ to the ground potential (zero volts), and the address driver 55 sets the column electrodes D₁ to Dₘ to the ground potential (zero volts). The application of the sustain pulse IP causes sustain discharge between the row electrodes X and Y in the discharge cell PC set to the turn-on mode described above. In response to the sustain discharge, light is emitted from the fluorescent layer 17 through the front transparent substrate 10 to the outside, whereby display luminescence is made once, corresponding to the brightness weight of the subfield SF2. The application of the sustain pulse IP also causes discharge between the row electrode Y and the column electrode D in the discharge cell PC set to the turn-on mode. Such discharge and the sustain discharge described above form negative-polarity wall charge in the vicinity of the row electrode Y and positive-polarity wall charge in the vicinity of each of the row electrode X and the column electrode D in the discharge cell PC. After the sustain pulse IP has been applied, the Y-electrode driver 53 applies the wall charge adjustment pulse CP having a negative-polarity peak potential and a waveform in which the potential at the front edge slowly changes with time as shown in FIG. 10 to the row electrodes Y₁ to Yₙ. The application of the wall charge adjustment pulse CP causes weak erase discharge in the discharge cell PC in which the sustain discharge described above has occurred, and part of the wall charge formed in the discharge cell PC is erased. In this way, the amount of wall charge in the discharge cell PC is adjusted to the amount that can adequately cause selective erase address discharge in the following selective erase address step W_{D}.

In the selective erase address step W_{D} in each of the subfields SF3 to SF14, the Y-electrode driver 53 sequentially and selectively applies a erase scan pulse SP_{D} having a negative-polarity peak potential to the row electrodes Y₁ to Yₙ while applying a base pulse BP⁺ having a predetermined positive-polarity base potential to the row electrodes Y₁ to Yₙ, as shown in FIG. 10. The peak potential of the base pulse BP⁺ is set to a potential that can prevent discharge from accidentally occurring between the row electrodes X and Y for the period in which the selective erase address step W_{D} is carried out. The X-electrode driver 51 sets the row electrodes X₁ to Xₙ to the ground potential (zero volts) for the period in which the selective erase address step W_{D} is carried out. In the selective erase address step W_{D}, the address driver 55 first converts the pixel drive data bit that corresponds to the subfield SF in question into a pixel data pulse DP having the pulse voltage according to the logic level of the pixel drive data bit. For example, when a pixel drive data bit having a logic level 1 at which the discharge cell PC should transit from the turn-on mode to the turn-off mode is supplied, the address driver 55 converts the pixel drive data bit into a pixel data pulse DP having a positive-polarity peak potential. On the other hand, when a pixel drive data bit having a logic level 0 at which the present state of the discharge cell PC should be maintained is supplied, the pixel drive data bit is converted into a pixel data pulse DP having a low voltage (zero volts). The address driver 55 then applies the pixel data pulses DP for each display line (m pixel data pulses) to the column electrodes D₁ to Dₘ in synchronization with the application timing of the erase scan pulse SP_{D}. In this process, selective erase address discharge occurs between the column electrode D and the row electrode Y in the discharge cell PC to which the erase scan pulse SP_{D} is applied and at the same time the high-voltage pixel data pulse DP is applied. The selective erase address discharge sets the discharge cell PC to the state in which positive-polarity wall charge is formed in the vicinity of each of the row electrodes X and Y and negative-polarity wall charge is formed in the vicinity of the column electrode D, specifically, the discharge cell PC is set to the turn-off mode. On the other hand, no selective erase address discharge described above occurs between the column electrode D and the row electrode Y in the discharge cell PC to which the erase scan pulse SP_{D} is applied and at the same time the pixel data pulse DP having a low voltage (zero volts) is applied. Therefore, the discharge cell PC maintains the state immediately before this step (the turn-on mode, the turn-off mode).

In the sustain step I in each of the subfields SF3 to SF14, the X-electrode driver 51 and the Y-electrode driver 53 apply the sustain pulse IP having a positive-polarity peak potential to the row electrodes X₁ to Xₙ and Y₁ to Yₙ in such a way that the application is made alternately to the row electrodes X and Y and repeated a number of times (even number) that corresponds to the brightness weight of the subfield in question, as shown in FIG. 10. Whenever the sustain pulse IP is applied, sustain discharge occurs between the row electrodes X and Y in the discharge cell PC set to the turn-on mode. In response to the sustain discharge, light is emitted from the fluorescent layer 17 through the front transparent substrate 10 to the outside, whereby display luminescence is made a number of times that corresponds to the brightness weight of the subfield SF in question. In this process, a negative-polarity wall charge is formed in the vicinity of the row electrode Y and a positive-polarity wall charge is formed in the vicinity of each of the row electrode X and the column electrode D in the discharge cell PC in which the last sustain pulse IP applied in the sustain step I in each of the subfields SF2 to SF 14 has caused the sustain discharge. After the last sustain pulse IP has been applied, the Y-electrode driver 53 applies the wall charge adjustment pulse CP having a negative-polarity peak potential and a waveform in which the potential at the front edge slowly changes with time as shown in FIG. 10 to the row electrodes Y₁ to Yₙ. The application of the wall charge adjustment pulse CP causes a weak erase discharge in the discharge cell PC in which the sustain discharge described above has occurred, and part of the wall charge formed in the discharge cell PC is erased. In this way, the amount of wall charge in the discharge cell PC is adjusted to the amount that can adequately cause a selective erase address discharge in the following selective erase address step W_{D}.

After the sustain step I in the last subfield SF14 is completed, the Y-electrode driver 53 applies an erase pulse EP having a negative-polarity peak potential to all of the row electrodes Y₁ to Yₙ. The application of the erase pulse EP causes erase discharge only in the discharge cells PC in the turn-on mode. The erase discharge causes the discharge cells PC in the turn-on mode to transit to the turn-off mode.

The drive operation described above is carried out based on the 16 pixel drive data GD shown in FIG. 8.

First, in the second grayscale representing the brightness one step higher than that of the first grayscale representing the black display (brightness level: 0), the selective write address discharge for setting a discharge cell PC to the turn-on mode is produced only in the subfield SF1 among the subfields SF1 to SF 14 so as to cause the discharge cell PC set to the turn-on mode to undergo the weak luminescence discharge process (indicated by the open rectangle), as shown in FIG. 8. The brightness level of the luminescence accompanying the selective write address discharge and the weak luminescence discharge is lower than the brightness level of the luminescence accompanying single sustain discharge. Therefore, provided that the brightness level perceived in the sustain discharge is “1”, the second grayscale represents the brightness that corresponds to the brightness level “α” that is lower than the brightness level “1”.

In the third grayscale representing the brightness one step higher than that of the second grayscale, the selective write address discharge for setting a discharge cell PC to the turn-on mode is produced (indicated by the double circle) only in the subfield SF2 among the subfields SF1 to SF 14, and the selective erase address discharge for causing the discharge cell PC to transit to the turn-off mode is produced (indicated by the filled circle) in the following subfield F3. Therefore, in the third grayscale, luminescence accompanying a single sustain discharge is made only in the sustain step I in the subfield SF2 among the subfields SF1 to SF 14 to represent the brightness that corresponds to the brightness level “1”.

In the fourth grayscale representing the brightness one step higher than that of the third grayscale, the selective write address discharge for setting a discharge cell PC to the turn-on mode is first produced in the subfield SF1 so as to cause the discharge cell PC set to the turn-on mode to undergo the weak luminescence discharge process (indicated by the open rectangle). In the fourth grayscale, the selective write address discharge for setting the discharge cell PC to the turn-on mode is further produced (indicated by the double circle) only in the subfield SF2 among the subfields SF1 to SF 14, and the selective erase address discharge for causing the discharge cell PC to transit to the turn-off mode is produced (indicated by the filled circle) in the following subfield SF3. Therefore, in the fourth grayscale, since luminescence having the brightness level “α” is made in the subfield SF1 and single sustain discharge accompanied by luminescence having the brightness level “1” is produced in SF2, the brightness that corresponds to a brightness level of “α”+“1” is expressed.

In each of the fifth to sixteenth grayscales, the selective write address discharge for setting a discharge cell PC to the turn-on mode is produced in the subfield SF1 so as to cause the discharge cell PC set to the turn-on mode to undergo the weak luminescence discharge process (indicated by the open rectangle). The selective erase address discharge for causing the discharge cell PC to transit to the turn-off mode is produced only in a single subfield that corresponds to the grayscale in question (indicated by the filled circle). Therefore, in each of the fifth to sixteenth grayscales, after the weak luminescence discharge is produced in the subfield SF1 and a single sustain discharge is produced in SF2, a sustain discharge is produced for each of the successive subfields (indicated by open circles) in a number that corresponds to the grayscale in question. The discharge is produced the number of times assigned to the corresponding subfield. In this way, in each of the fifth to sixteenth grayscales, one perceives the brightness that corresponds to the brightness level “α”+“the total number of sustain discharge that occurs in a single field (or a single frame) display period.”

Therefore, according to the drive operation shown in FIGS. 8 to 10, the brightness levels ranging from “0” to “255+α” can be expressed in 16 steps shown in FIG. 8.

In the above drive operation, the weak luminescence discharge instead of the sustain discharge is produced as the discharge that contributes to a displayed image in the subfield SF1 whose brightness weight is the smallest. Since the weak luminescence discharge occurs between the column electrode D and the row electrode Y, the brightness level of the luminescence accompanying the weak luminescence discharge is lower than that of the sustain discharge that occurs between the row electrodes X and Y. Therefore, when the weak luminescence discharge is used to represent the brightness (second grayscale) one step higher than the black display (brightness level: 0), the difference in brightness between the brightness level 0 and the brightness level of the second grayscale is smaller than in the case where the sustain discharge is used to express the second grayscale. Therefore, the grayscale expressing capability is enhanced in expressing a low-brightness image. Further, in the second grayscale, since no reset discharge occurs in the second reset step R2 in the subfield SF2 that follows SF1, there is no reduction in dark contrast associated with the reset discharge. In the drive operation shown in FIG. 8, although the weak luminescence discharge accompanied by luminescence having the brightness level α is produced in the subfield SF1 also in the fourth grayscale and in the following grayscales, the weak luminescence discharge may not be produced in the third grayscale and in the following grayscales. In fact, since the luminescence accompanying the weak luminescence discharge has significantly low brightness (brightness level: α), in the fourth grayscale and the following grayscales in which the weak luminescence discharge is combined with the sustain discharge accompanying higher-brightness luminescence, an increase in brightness due to the brightness level α may not be perceived. In such a case, there is no need to produce the weak luminescence discharge.

The plasma display apparatus shown in FIG. 1 is equipped with the PDP 50, which is characterized by a significantly enhanced discharge probability, a shortened discharge delay period, and weakened discharge as compared to a conventional PDP by using the magnesium oxide layer 13 and the fluorescent layer 17 shown in FIG. 3, both of which contain a CL luminescence MgO crystal. Since the PDP 50 can reliably cause a weakened reset discharge, luminescence that accompanies the reset discharge but does not contribute to a displayed image decreases, whereby the contrast of the image, in particular, the dark contrast when a dark image is displayed, can be enhanced.

Referring back to FIG. 1, the plasma display apparatus of the embodiment includes the temperature sensor 100. The temperature sensor 100 measures the temperature of the PDP 50 (the temperature of the apparatus, such as the temperature of the front transparent substrate 10 or the rear substrate 14, for example), or the temperature around the PDP 50 (environment temperature), and supplies a signal indicative of the measured temperature to the drive control circuit 56. The temperature of the PDP 50 itself (apparatus temperature) and the environment temperature around the PDP 50 are hereinafter collectively referred simply to as the temperature TM of the PDP 50.

The drive control circuit 56 determines whether or not the measured temperature (TM) supplied from the temperature sensor 100 falls within a predetermined temperature range (TL≦TM≦TH), where TL and TH denote the lower and upper limits of the temperature range, respectively.

When the measured temperature (TM) falls outside a predetermined temperature range, specifically, when the measured temperature (TM) is lower than the lower limit TL or higher than the upper limit TH, the following voltage adjustment (i) and/or (ii) is made.

Specifically, the drive control circuit 56
(i) reduces the absolute value of the voltage (predetermined fixed positive-polarity potential: V1) of the base pulse BP₂ applied to the row electrodes X₁ to Xₙ (second row electrodes) in the second half of the second reset step R2, and/or
(ii) reduces the absolute value (amplitude) of the peak voltage (V2) of the negative-polarity reset pulse RP2_{Y2} applied to the row electrodes Y₁ to Yₙ (first row electrodes) in the second half of the second reset step R2.

That is, at a temperature outside a predetermined temperature range (at a higher or lower temperature), the discharge characteristics are unstable and the weak discharge described above is likely to occur. In an adverse environment in which the weak discharge is likely to occur, the largest potential difference between the row electrodes X₁ to Xₙ and the row electrodes Y₁ to Yₙ during the second reset discharge is reduced. In the embodiment, since the base pulse BP₂ is of positive polarity and the reset pulse RP2_{Y2} is of negative polarity, (i) the voltage of the base pulse BP₂ is reduced, and (ii) the voltage of the reset pulse RP2_{Y2} is increased (the absolute value is reduced). In general, the absolute values of the voltage of the base pulse BP₂ and/or the voltage of the reset pulse RP2_{Y2} may be reduced (the potential difference between the row electrodes X₁ to Xₙ and the row electrodes Y₁ to Yₙ is reduced) in accordance with the polarities of the base pulse BP₂ and the reset pulse RP2_{Y2}.

In such a configuration, the discharge between the row electrodes X₁ to Xₙ and the row electrodes Y₁ to Yₙ during the second reset discharge is weakened, and the amount of Y-side negative-polarity wall charge and the amount of X-side positive-polarity wall charge left at the end of the reset step (during the write address step) become greater than those in a case where the potential difference is large. Since the amount of initial residual wall charge is increased in the following write address step even when the weak discharge described above reduces the amount of wall charge in an adverse environment, the write address discharge is apt to occur between the row electrodes X₁ to Xₙ and the column electrodes (address electrodes) D and between the row electrodes X₁ to Xₙ (electrodes X) and the row electrodes Y₁ to Yₙ (electrodes Y), whereby no write failure will occur.

More specifically, in the write address step, application of the negative-polarity base pulse to the electrodes Y and the positive-polarity address pulse to the column electrodes (address electrodes) D may disadvantageously cause a very weak discharge between the electrodes Y and the address electrodes before the scan pulse is applied, that is, when no pulse is applied. The weak discharge disadvantageously reduces a trace or minute quantities of negative-polarity wall charge left on the electrodes Y and the positive-polarity wall charge present on the address electrodes. In this case, no write discharge will occur between the electrodes Y and the address electrodes in the following stage when the scan pulse is applied. If no write discharge occurs, the cell in which no write discharge has occurred disadvantageously becomes a dark point.

In particular, in the PDP of the embodiment in which the protective layer and the fluorescent layer contain a CL luminescence MgO crystal, good discharge characteristics of the PDP have the opposite effect of making a weak or feeble discharge more likely. The weak discharge continuously occurs over the address step period. Therefore, the longer the address period, the more the wall charge is reduced. Therefore, in a scan line having a later scan order, the chance of causing the address discharge decreases. In particular, in the write address step, the application of the negative-polarity base potential to the electrodes Y is likely to cause a weak discharge between the address electrodes and the electrodes Y. When write failure occurs in the write address step, the cell in which no write discharge has occurred becomes a dark point because the erase address step is carried out in the following subfields, resulting in significant reduction in display quality. Moreover, in an aged apparatus or in an abnormal temperature environment, the discharge characteristics between the electrodes Y and the address electrodes are unstable, and hence the weak discharge occurs readily. The invention can eliminate the effect of the weak discharge described above in such conditions.

A variety of modifications of the embodiment will be described below. No description will be made of the points similar to those described above.

First, in a first modification of the first embodiment, when the measured temperature (TM) falls outside a predetermined temperature range (TL≦TM≦TH), the following adjustment (iii) is made in addition to the voltage adjustments (i) and/or (ii) described above. The adjustment (iii) is preferably made in addition to the adjustments (i) and (ii).

Specifically, the drive control circuit 56 (iii) increases the absolute value (amplitude) of the pulse height (V3) of the reset pulse RP2_{Y1} applied to the row electrodes Y₁ to Yₙ in the first half of the second reset step R2 in the subfield S2. In the embodiment, since the reset pulse RP2_{Y1} is of positive polarity, the voltage (V3) of the reset pulse RP2_{Y1} is increased.

That is, in the modification, when the measured temperature (TM) falls outside a predetermined temperature range (TL≦TM≦TH) (specifically, a condition in which a weak discharge occurs readily), the potential (amplitude) of the positive-polarity first reset pulse is increased.

In such a configuration, the discharge between the electrodes Y and the address electrodes becomes stronger during the first reset discharge, and the amount of Y electrode-side negative-polarity wall charge left at the end of the reset step (during the write address step) increases. Since the amount of initial residual wall charge is even larger than that in the first embodiment in the following write address step even when a weak discharge reduces the amount of wall charge in an adverse environment, the write address discharge readily occurs between the electrodes Y and the address electrodes and between the electrodes X and the electrodes Y, whereby no write failure will occur.

A second modification of the first embodiment will be described below. In the second modification of the embodiment, when the measured temperature (TM) falls outside a predetermined temperature range (TL≦TM≦TH), the following adjustment (iv) is made in addition to at least one of the voltage adjustments (i), (ii), and (iii) described above. The adjustment (iv) is preferably made in addition to the adjustments (i) and/or (ii).

Specifically, the drive control circuit 56 (iv) increases the pulse height (V4) of the write scan pulse SP_{W} sequentially and selectively applied to the row electrodes Y₁ to Yₙ in the second selective write address step W2_{W} in the subfield S2. In the embodiment, since the write scan pulse SP_{W} has a negative-polarity peak potential, the voltage (V4) of the write scan pulse SP_{W} is reduced.

That is, in this modification, the pulse height of the write scan pulse SP_{W} is increased in a condition that a weak discharge readily occurs. In such a configuration, the potential differences between the electrodes Y and the address electrodes and between the electrodes X and the electrodes Y increase during the write address step, and address discharge readily occurs. Therefore, in the write address step, even when the weak discharge described above reduces the wall charge in an adverse environment, the write address discharge occurs more readily than in the first embodiment between the electrodes Y and the address electrodes and between the electrodes X and the electrodes Y, whereby no write failure will occur.

A third modification of the first embodiment will be described below. In the third modification of the embodiment, when the measured temperature (TM) falls outside a predetermined temperature range (TL≦TM≦TH), the following adjustment (v) is made in addition to at least one of the voltage adjustments (i) to (iv) described above. The adjustment (v) is preferably made in addition to the adjustments (i) and/or (ii).

Specifically, the drive control circuit 56 (v) shortens the length L of the period of the second selective write address step W2_{W} in the subfield SF2 (see FIG. 10). In this case, for example, the length L of the period is shortened by increasing the scan rate of the write scan pulse SP_{W}. The time created by shortening the length L of the period may be allocated at the end of the erase step E (the end of the last subfield).

The length L of the period may alternatively be shortened, for example, by reducing the width of the write scan pulse SP_{W} and the width of the address pulses that are in synchronization therewith. In this case, the pulse width may be shorter for a pulse having an earlier scan order.

That is, in this modification, the period (scan rate) of the write address step is shortened in an adverse environment in which a weak discharge readily occurs. As described above, since a weak discharge continuously occurs in the address period, it is more difficult to cause the address discharge for a scan line having a later scan order. Therefore, the scan rate is reduced in such a way that all of the lines are scanned before the weak discharge erases the necessary wall charge. In such a configuration, even in an adverse environment, the write address discharge occurs more readily than in the first embodiment between the electrodes Y and the address electrodes and between the electrodes X and the electrodes Y, whereby no write failure will occur.

### Second Embodiment

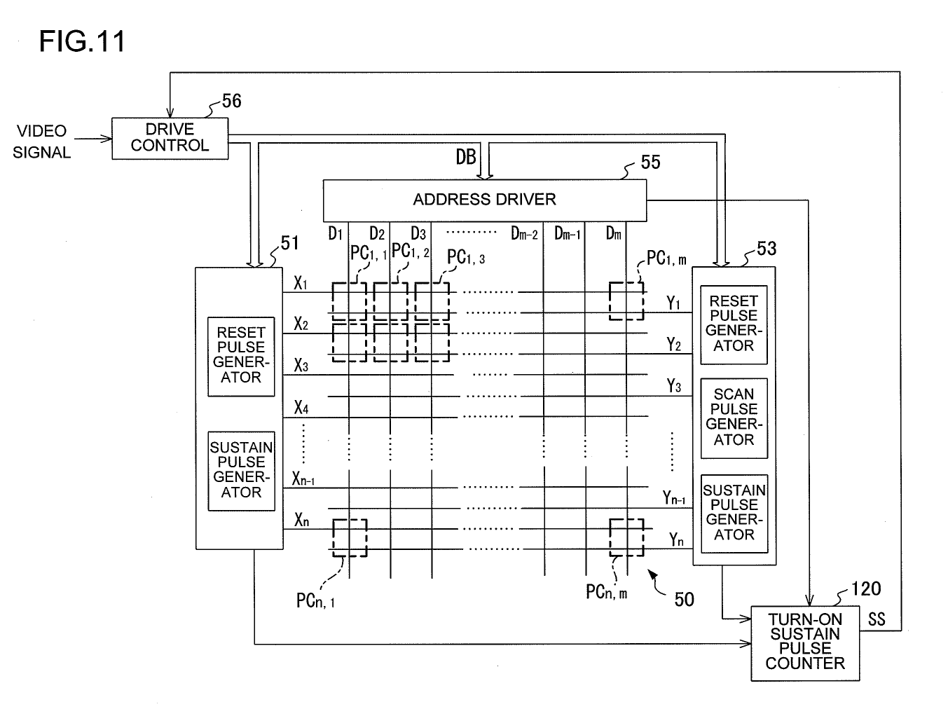

FIG. 11 shows a schematic configuration of a plasma display apparatus that is a second embodiment of the invention.

The plasma display apparatus shown in FIG. 11 includes a turn-on sustain pulse counter 120 instead of the temperature sensor 100 shown in FIG. 1. The other configurations and the variety of drive operations are the same as those in the plasma display apparatus shown in FIG. 1.

The turn-on sustain pulse counter 120 first counts, for each subfield (SF), the number of pixel data pulses that correspond to the turn-on mode (which will be described later) among the pixel data pulses applied to the discharge cells PC_{1,1} to PC_{n,m} by the address driver 55. The turn-on sustain pulse counter 120 then multiplies, for each SF, the number of pixel data pulses that correspond to the turn-on mode by the number of sustain pulses repeatedly applied to a pair of row electrodes X and Y by the X-electrode driver 51 and the Y-electrode driver 53, and accumulates the result of the multiplication. The result of the multiplication is held even after the plasma display apparatus is turned off, and becomes the initial value of the turn-on sustain pulse counter 120 when the plasma display apparatus is turned on the next time. Specifically, the turn-on sustain pulse counter 120 counts the accumulated number of application of the sustain pulse (hereinafter referred to as the accumulated number of turn-on sustain pulses) applied to the discharge cell PC in the turn-on mode, that is, sustain pulses that will contribute to actual sustain discharge, among the sustain pulses repeatedly applied to each of the discharge cells PC during the period starting from the shipment from the factory to the present time. The turn-on sustain pulse counter 120 supplies a turn-on sustain pulse accumulated number signal SS indicative of the accumulated number of turn-on sustain pulses to the drive control circuit 56.

To calculate the number of turn-on sustain pulses for each field, an average picture level APL (%) for each field is determined, and then multiplied by the total number of sustain pulses applied in the field. The accumulated number of turn-on sustain pulses (SS) can alternatively be determined by accumulating the number of turn-on sustain pulses for each field.

The drive control circuit 56 first determines whether or not the accumulated number of turn-on sustain pulses SS expressed in the form of the turn-on sustain pulse accumulated number signal SS is larger than a predetermined number (SM).

When the drive control circuit 56 determines that the accumulated number of turn-on sustain pulses is larger than a predetermined number (SM<SS), the drive control circuit 56 makes voltage adjustments (i) and/or (ii) similar to those in the first embodiment.

Specifically, the drive control circuit 56
(i) reduces the absolute value of the voltage (predetermined fixed positive-polarity potential: V1) of the base pulse BP₂ applied to the row electrodes X₁ to Xₙ in the second half of the second reset step R2, and/or
(ii) reduces the absolute value (amplitude) of the peak voltage (V2) of the negative-polarity reset pulse RP2_{Y2} applied to the row electrodes Y₁ to Yₙ in the second half of the second reset step R2. In this embodiment, as in the embodiment described above, since the base pulse BP₂ is of positive polarity and the reset pulse RP2_{Y2} is of negative polarity, (i) the voltage of the base pulse BP₂ is reduced, and (ii) the voltage of the reset pulse RP2_{Y2} is increased (the absolute value is reduced). In general, the absolute values of the voltage of the base pulse BP₂ and/or the voltage of the reset pulse RP2_{Y2} may be reduced in accordance with the polarities of the base pulse BP₂ and the reset pulse RP2_{Y2}.

That is, in the plasma display apparatus in this embodiment, after the accumulated number of sustain discharge in the PDP 50 becomes larger than a predetermined number, the driving operations (i) and (ii) described above are carried out. A PDP is characterized in that after it has been used for a long period, the discharge characteristics become unstable due to aging, and the weak discharge described above occurs readily. Specifically, after a predetermined accumulated number of sustain pulses have been applied, that is, when the weak discharge occurs readily, an adjustment is made in the driving operation in such a way that the potential difference between the electrodes X and the electrodes Y in the second reset step decreases.

In such a configuration, the discharge between the electrodes X and the electrodes Y in the second reset discharge is weakened, and the amount of Y electrode-side negative-polarity wall charge and the amount of the X electrode-side positive-polarity wall charge left at the end of the reset step (during the write address step) become greater than those in a case where the potential difference is large. Therefore, since the amount of the initial residual wall charge is adjusted to be larger (i.e., a compensation is made) in the following write address step even when the weak discharge described above reduces the amount of wall charge, the write address discharge readily occurs between the electrodes Y and the address electrodes and between the electrodes X and the electrodes Y, whereby no write failure will occur.

When the accumulated number of turn-on sustain pulses SS becomes larger than a predetermined number SM, the voltages may be changed in the voltage adjustments in the driving operations (i) and/or (ii) in a gradual or stepwise manner. Such control may be carried out also in the above and following embodiments.

A variety of modifications of this embodiment will be described below. No description will be made of the points similar to those described above.

First, in a first modification of the second embodiment, when the accumulated number of turn-on sustain pulses becomes larger than a predetermined number (SM<SS), the drive control circuit 56 makes an adjustment (iii) similar to that in the first embodiment in addition to the adjustments (i) and/or (ii) described above.

Specifically, the drive control circuit 56 (iii) increases the absolute value (amplitude) of the pulse height (V3) of the reset pulse RP2_{Y1} applied to the row electrodes Y₁ to Yₙ in the first half of the second reset step R2 in the subfield SF2.

The adjustments (i) to (iii) are similar to those in the first embodiment described above, and it is similarly preferable to make all of the adjustments (i) to (iii).

In this modification, after a predetermined accumulated number of sustain pulses have been applied, that is, when a weak discharge readily occurs, the absolute value of the voltage (V3) of the first reset pulse is increased. Since the first reset pulse RP2_{Y1} is of positive polarity in the above description, the voltage (V3) is increased.

In such a configuration, the discharge between the electrodes Y and the address electrodes during the first reset discharge becomes stronger, and the amount of Y electrode-side negative-polarity wall charge left at the end of the reset step (during the write address step) increases. Therefore, since the amount of initial residual wall charge is adjusted to be even larger (i.e., a compensation is made) even when a weak discharge due to the use for a long period reduces the amount of wall charge, the write address discharge readily occurs between the electrodes Y and the address electrodes and between the electrodes X and the electrodes Y in the following write address step, whereby no write failure will occur. A second modification of the second embodiment will be described. In the second modification, when the accumulated number of turn-on sustain pulses becomes larger than a predetermined number (SM<SS), the following adjustment (iv) is made in addition to at least one of the adjustments (i), (ii), and (iii) described above. The adjustment (iv) is preferably made in addition to the adjustments (i) and/or (ii). The adjustments (i) to (iv) are similar to those in the first embodiment.

Specifically, the drive control circuit 56 (iv) increases the pulse height (V4) of the write scan pulse SP_{W} sequentially and selectively applied to the row electrodes Y₁ to Yₙ in the second selective write address step W2_{W} in the subfield SF2. Since the write scan pulse SP_{W} has a negative-polarity peak potential in this embodiment, the voltage (V4) of the write scan pulse SP_{W} is reduced.

That is, in this modification, the pulse height of the write scan pulse SP_{W} is increased after the use for a long period, that is, when a weak discharge readily occurs. In such a configuration, the potential differences between the electrodes Y and the address electrodes and between the electrodes X and the electrodes Y during the write address step increase, whereby the address discharge is made to occur readily. Therefore, since the amount of initial residual wall charge is adjusted (compensated) to be even larger in the write address step even when a weak discharge due to the use for a long period reduces the amount of wall charge, the write address discharge readily occurs between the electrodes Y and the address electrodes and between the electrodes X and the electrodes Y in the following write address step, whereby no write failure will occur.

A third modification of the second embodiment will be described below. In the third modification, when the accumulated number of turn-on sustain pulses becomes larger than a predetermined number (SM<SS), the following adjustment (v) is made in addition to at least one of the voltage adjustments (i) to (iv) described above. The adjustment (v) is preferably made in addition to the adjustments (i) and/or (ii). The adjustments (i) to (v) are similar to those in the first embodiment.

Specifically, the drive control circuit 56

(v) shortens the length L of the period of the second selective write address step W2_{W} in the subfield SF2 (see FIG. 10). In this case, for example, the length L of the period is shortened by increasing the scan rate of the write scan pulse SP_{W}. The time created by shortening the length L of the period may be allocated at the end of the erase step E (the end of the last subfield). Alternatively, the length L of the period may be shortened by reducing the width of the write scan pulse SP_{W} and the width of the address pulses that are in synchronization therewith. In this case, the pulse width may be shorter for a pulse having an earlier scan order.

That is, in this modification, the period of the write address step (scan rate) is shortened after the use for a long period, that is, when a weak discharge readily occurs. As described above, since a weak discharge continuously occurs in the address period, it is more difficult to cause the address discharge for a scan line having a later scan order. Therefore, the scan rate is reduced in such a way that all of the lines are scanned before the weak discharge erases the necessary wall charge. In such a configuration, even in an adverse environment, the write address discharge occurs more readily than in the first embodiment between the electrodes Y and the address electrodes and between the electrodes X and the electrodes Y, whereby no write failure will occur.

### Third Embodiment

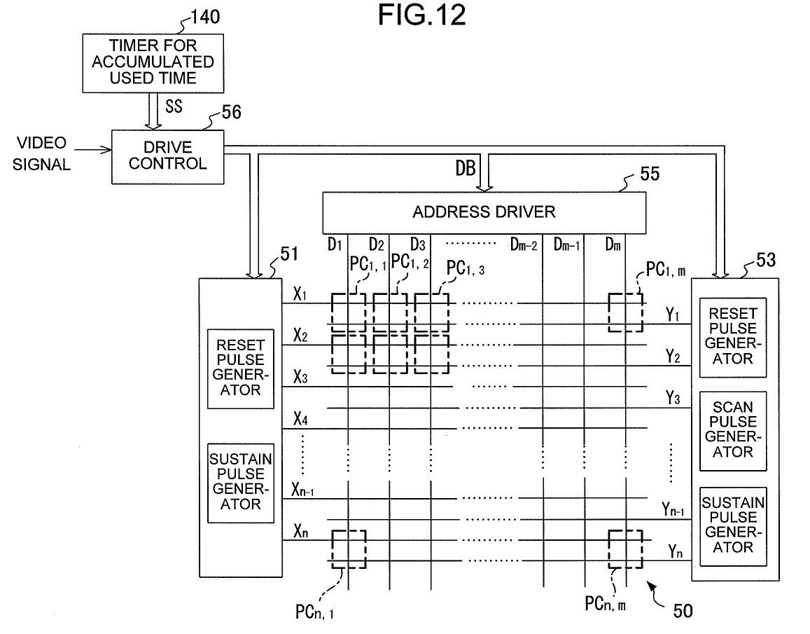

FIG. 12 shows a schematic configuration of a plasma display apparatus that is a third embodiment of the invention.

The plasma display apparatus shown in FIG. 12 includes a timer 140 for accumulated used time instead of the turn-on sustain pulse counter 120 shown in FIG. 11. The other configurations and the variety of drive operations are the same as those in the plasma display apparatus shown in FIG. 11.

The timer 140 for accumulated used time starts time measurement in response to the first power-on action after the plasma display apparatus has been shipped from the factory, and terminates the time measurement operation in response to the power-off action. In this process, the timer 140 for accumulated used time stores the lapse of time at the point of the power-off action as an initial value at the next power-on action in a built-in register (not shown). That is, the timer 140 for accumulated used time counts accumulated used time after the shipment from the factory by starting to count the lapse of time starting from the initial value stored in the built-in register in response to the next power-on action. In this process, the timer 140 for accumulated used time regards the present accumulated used time as the accumulated number of turn-on sustain pulses described above, and supplies the turn-on sustain pulse accumulated number signal SS indicative of the accumulated number of turn-on sustain pulses to the drive control circuit 56.

Therefore, according to the plasma display apparatus shown in FIG. 12, drive control similar to those in the first and second embodiments and the modifications thereof is carried out in accordance with the accumulated used time after the shipment from the factory.

More specifically, the drive control circuit 56 first determines whether or not the accumulated used time (UT) is longer than a predetermined time (UM). When the accumulated used time is longer than the predetermined time (UM<UT), the drive control circuit 56 makes adjustments (i) and/or (ii) similar to those in the first and second embodiments. Further, the adjustments (iii) to (v) may be made as in the first and second embodiments.

Advantageous effects when the adjustments (i) to (v) are thus made are similar to those in the first and second embodiments.

As described above in detail, in the invention, the largest potential difference between the row electrodes (the electrodes X and the electrodes Y) is reduced in conditions under which a weak discharge readily occurs; for example, when the temperature of the PDP falls outside a predetermined temperature range (a higher or lower temperature) and when the PDP has been used longer than a predetermined period. In such a configuration, since the amount of Y-electrode-side wall charge and the X-electrode-side wall charge having the polarity opposite to that of the Y-electrode-side wall charge left at the end of the reset step (during the write address step) increases, the write address discharge thus readily occurs, whereby write failure can be effectively prevented.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No. 2008-049611 which is hereby incorporated by reference.

What is claimed is:

1. A method for driving a plasma display panel in accordance with data for individual pixels based on a video signal, the plasma display panel including first and second substrates facing each other across a discharge space in which a discharge gas is sealed; discharge cells formed at intersections of a plurality of row electrode pairs each having first and second row electrodes that are formed on said first substrate, and a plurality of column electrodes that are formed on said second substrate; and a fluorescent layer formed on a surface in contact with said discharge space in each of said discharge cells, the fluorescent layer containing a fluorescent material; the method comprising:
an address step of setting said discharge cell to one of a turn-on mode and a turn-off mode selectively in each of a plurality of subfields for individual unit display periods in said video signal; and
a sustain step;
wherein in one of said plurality of subfields, a reset step of initializing said discharge cell to the other one of said turn-on mode and said turn-off mode is carried out before said address step;
said reset step includes a first half of said reset step in which a first reset pulse is applied to said first row electrode, and a second half of said reset step that follows said first half of said reset step and in which a second reset pulse having a polarity that is opposite that of said first reset pulse is applied to said first row electrode; and
when a temperature of the plasma display panel falls outside a predetermined temperature range, the largest potential difference between said first and second row electrodes is reduced in said second half of said reset step.

2. The method for driving a plasma display panel of claim 1, wherein:
said second reset pulse is a negative-polarity pulse, and the potential applied to said second row electrode in said second half of said reset step is of positive polarity; and
when the temperature of said plasma display panel falls outside a predetermined temperature range, said positive-polarity potential applied to said second row electrode is reduced.

3. The method for driving a plasma display panel of claim 1, wherein:
said second reset pulse is a negative-polarity pulse, and the potential applied to said second row electrode in said second half of said reset step is of positive polarity; and
when the temperature of said plasma display panel falls outside a predetermined temperature range, a peak potential of said second reset pulse is increased.

4. The method for driving a plasma display panel of claim 1, wherein:
said first reset pulse is a positive-polarity pulse; and
when the temperature of said plasma display panel falls outside a predetermined temperature range, a peak height of the potential of said first reset pulse is increased.

5. The method for driving a plasma display panel of claim 1, wherein when the temperature of said plasma display panel falls outside a predetermined temperature range, the potential of a positive-polarity base pulse applied to said second row electrode in the address step in said one of the subfields is increased.

6. The method for driving a plasma display panel of claim 1, wherein when the temperature of said plasma display panel falls outside a predetermined temperature range, the absolute value of a potential of a negative-polarity scan pulse sequentially applied to said first row electrode in the address step in said one of the subfields is increased.

7. The method for driving a plasma display panel of claim 1, wherein when the temperature of said plasma display panel falls outside a predetermined temperature range, the period of the address step in said one of the subfields is shortened.

8. The method for driving a plasma display panel of claim 1, wherein:
the address step in said one of the subfields is a selective write address step in which an address discharge is produced and said discharge cell is set to the turn-on mode; and
the address step in each of the subfields that follow said one of the subfields is a selective erase address step in which an address discharge is produced and said discharge cell is set to the turn-off mode.

9. The method for driving a plasma display panel of claim 1, wherein a voltage configured to set said first row electrode to an anode and said column electrode to a cathode is applied between said first row electrode and said column electrode in said first half of said reset step, whereby a reset discharge is produced between said first row electrode and said column electrode.

10. The method for driving a plasma display panel of claim 1, wherein a protective layer on a dielectric layer for covering said row electrode pairs contains a magnesium oxide crystal that is excited by an electron beam to cause cathode luminescence having a peak within a wavelength range between 200 and 300 nm.

11. The method for driving a plasma display panel of claim 1, wherein:
said fluorescent layer contains a magnesium oxide; and
said magnesium oxide contains a magnesium oxide crystal that is excited by an electron beam to cause cathode luminescence having a peak within a wavelength range between 200 and 300 nm.

12. The method for driving a plasma display panel of claim 10, wherein said magnesium oxide crystal has a particle diameter of 2000 Å or larger.

13. The method for driving a plasma display panel of claim 10, wherein said magnesium oxide crystal is in contact with said discharge gas in said discharge space.

14. A method for driving a plasma display panel in accordance with data for individual pixels based on a video signal, the plasma display panel including first and second substrates facing each other across a discharge space in which a discharge gas is sealed; discharge cells formed at intersections of a plurality of row electrode pairs formed from first and second row electrodes that are formed on said first substrate, and a plurality of column electrodes that are formed on said second substrate; and a fluorescent layer formed on a surface in contact with said discharge space in each of said discharge cells, the fluorescent layer containing a fluorescent material;
the method comprising:
an address step of setting said discharge cell to one of a turn-on mode and a turn-off mode selectively in each of a plurality of subfields for individual unit display periods in the video signal; and
a sustain step;
wherein in one of said plurality of subfields, a reset step of initializing said discharge cell to the other one of said turn-on mode and said turn-off mode is carried out before said address step;
said reset step includes a first half of said reset step in which a first reset pulse is applied to said first row electrode, and a second half of said reset step that follows said first half of said reset step and in which a second reset pulse having a polarity that is opposite that of said first reset pulse is applied to said first row electrode; and
when an accumulated time over which said plasma display panel is used exceeds a predetermined time, or when an accumulated number of applications of a drive pulse that contributes to a grayscale display exceeds a predetermined value, the largest potential difference between said first and second row electrodes is reduced in said second half of said reset step.

15. The method for driving a plasma display panel of claim 14, wherein:
said second reset pulse is a negative-polarity pulse, and the potential applied to said second row electrode in said second half of said reset step is of positive polarity; and
when an accumulated time over which said plasma display panel is used exceeds a predetermined time, or when an accumulated number of applications of a drive pulse that contributes to a grayscale display exceeds a predetermined value, said positive-polarity potential applied to said second row electrode is lowered.

16. The method for driving a plasma display panel of claim 14, wherein:
said second reset pulse is a negative-polarity pulse, and the potential applied to said second row electrode in said second half of said reset step is of positive polarity; and
when an accumulated time over which said plasma display panel is used exceeds a predetermined time, or when an accumulated number of applications of a drive pulse that contributes to a grayscale display exceeds a predetermined value, a peak potential of said second reset pulse is increased.

17. The method for driving a plasma display panel of claim 14, wherein:
said first reset pulse is a positive-polarity pulse; and
when an accumulated time over which said plasma display panel is used exceeds a predetermined time, or when an accumulated number of applications of a drive pulse that contributes to a grayscale display exceeds a predetermined value, a peak height of the potential of said first reset pulse is increased.

18. The method for driving a plasma display panel of claim 14, wherein:
when an accumulated time over which said plasma display panel is used exceeds a predetermined time, or when an accumulated number of applications of a drive pulse that contributes to a grayscale display exceeds a predetermined value,
the potential of a positive-polarity base pulse applied to said second row electrode in the address step in said one of the subfields is increased.

19. The method for driving a plasma display panel of claim 14, wherein:
when an accumulated time over which said plasma display panel is used exceeds a predetermined time, or when an accumulated number of applications of a drive pulse that contributes to a grayscale display exceeds a predetermined value,
the absolute value of a potential of a negative-polarity scan pulse sequentially applied to said first row electrode in the address step in said one of the subfields is increased.

20. The method for driving a plasma display panel of claim 14, wherein:
when an accumulated time over which said plasma display panel is used exceeds a predetermined time, or when an accumulated number of applications of a drive pulse that contributes to a grayscale display exceeds a predetermined value,
the period of the address step in said one of the subfields is shortened.

21. The method for driving a plasma display panel of claim 14, wherein:
the address step in said one of the subfields is a selective write address step in which an address discharge is produced, and said discharge cell is set to the turn-on mode; and
the address step in each of the subfields that follow said one of the subfields is a selective erase address step in which an address discharge is produced, and said discharge cell is set to the turn-off mode.

22. The method for driving a plasma display panel of claim 14, wherein a voltage configured to set said first row electrode to an anode and said column electrode to a cathode is applied between said first row electrode and said column electrode in said first half of said reset step, whereby a reset discharge is produced between said first row electrode and said column electrode.

23. The method for driving a plasma display panel of claim 14, wherein a protective layer on a dielectric layer for covering said row electrode pairs contains a magnesium oxide crystal that is excited by an electron beam to cause cathode luminescence having a peak within a wavelength range between 200 and 300 nm.

24. The method for driving a plasma display panel of claim 14, wherein:
said fluorescent layer contains a magnesium oxide; and
said magnesium oxide contains a magnesium oxide crystal that is excited by an electron beam to cause cathode luminescence having a peak within a wavelength range between 200 and 300 nm.

25. The method for driving a plasma display panel of claim 23, wherein said magnesium oxide crystal has a particle diameter of 2000 angstroms or larger.

26. The method for driving a plasma display panel of claim 23, wherein said magnesium oxide crystal is in contact with said discharge gas in said discharge space.

27. The method for driving a plasma display panel of claim 11, wherein said magnesium oxide crystal has a particle diameter of 2000 Å or larger.

28. The method for driving a plasma display panel of claim 11, wherein said magnesium oxide crystal is in contact with said discharge gas in said discharge space.

29. The method for driving a plasma display panel of claim 24, wherein said magnesium oxide crystal has a particle diameter of 2000 angstroms or larger.

30. The method for driving a plasma display panel of claim 24, wherein said magnesium oxide crystal is in contact with said discharge gas in said discharge space.
